(19) United States
(12) Patent Application Publication
(10) Pub. No.: US 2008/0246280 A1
(43) Pub. Date: Oct. 9, 2008

(54) Generating system by using the sea power

(76) Inventor: Shu Lu, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/732,747

(22) Filed: Apr. 4, 2007

(51) Int. Cl. F03B 13/18

(52) U.S. Cl. 290/42

(57) ABSTRACT

A generating system includes an outer wall unit having an outlet conduit, an inner wall unit spaced from the outer wall unit, a receiving channel located between the outer wall unit and the inner wall unit to receive salt water of the sea to deliver the salt water to the outlet conduit, and a generating unit including a plurality of generating watermills driven by a flowing power of the salt water. The salt water directly flows from the receiving channel to the outlet conduit to drive and rotate the generating watermills so as to provide a generating function. Thus, the generating system is mounted on the sea coast to form an oceanic trench to collect the salt water of the sea to provide a generating function to produce an electric energy by using the natural resource.

### BACKGROUND OF THE INVENTION

1. Field of the Invention

The present invention relates to a generating system and, more particularly, to a generating system by using the sea power.

2. Description of the Related Art

A conventional tidal power plant is used to provide a generating function by using the sea power to produce an electrical energy for use with the people. Thus, such a generating device produces an electrical energy by using the natural resource without causing an environmental pollution.

### BRIEF SUMMARY OF THE INVENTION

In accordance with the present invention, there is provided a generating system, comprising an outer wall unit having an outlet conduit, an inner wall unit spaced from the outer wall unit, a receiving channel located between the outer wall unit and the inner wall unit to receive salt water of the sea from the outer wall unit and connected to the outlet conduit of the outer wall unit to deliver the salt water to the outlet conduit of the outer wall unit, and a generating unit including a plurality of generating watermills located between the receiving channel and the outlet conduit of the outer wall unit and driven by a flowing power of the salt water.

The primary objective of the present invention is to provide a generating system by using the natural resource or the sea power.

Another objective of the present invention is to provide a generating system, wherein the generating system is mounted on the sea coast to form an oceanic trench to collect the salt water of the sea to provide a generating function to produce an electric energy by using the natural resource to satisfy the requirements of the people and to prevent the environment from being polluted.

A further objective of the present invention is to provide a generating system, wherein the generating system is operated constantly by using the sea power to enhance the generating efficiency and to increase the economical profits largely.

A further objective of the present invention is to provide a generating system, wherein the salt water directly flows from the receiving channel to the outlet conduit to drive and rotate the generating watermills so as to provide a primary generating function, while partial of the salt water from the receiving channel in turn flows through the delivery watermills, the inlet pipes, the receiving chamber and the outlet pipes to drive and rotate the generating watermills so as to provide an auxiliary generating function, thereby greatly increasing the generating effect.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a generating system in accordance with the preferred embodiment of the present invention.

FIG. 2 is a top view of the generating system as shown in FIG. 1.

FIG. 3 is a locally enlarged view of the generating system as shown in FIG. 1.

FIG. 4 is a side view of the generating system as shown in FIG. 1.

FIG. 5 is a side cross-sectional view of a floating unit of the generating system as shown in FIG. 1.

FIG. 6 is an exploded perspective view of the floating unit of the generating system as shown in FIG. 5.

### DETAILED DESCRIPTION OF THE INVENTION

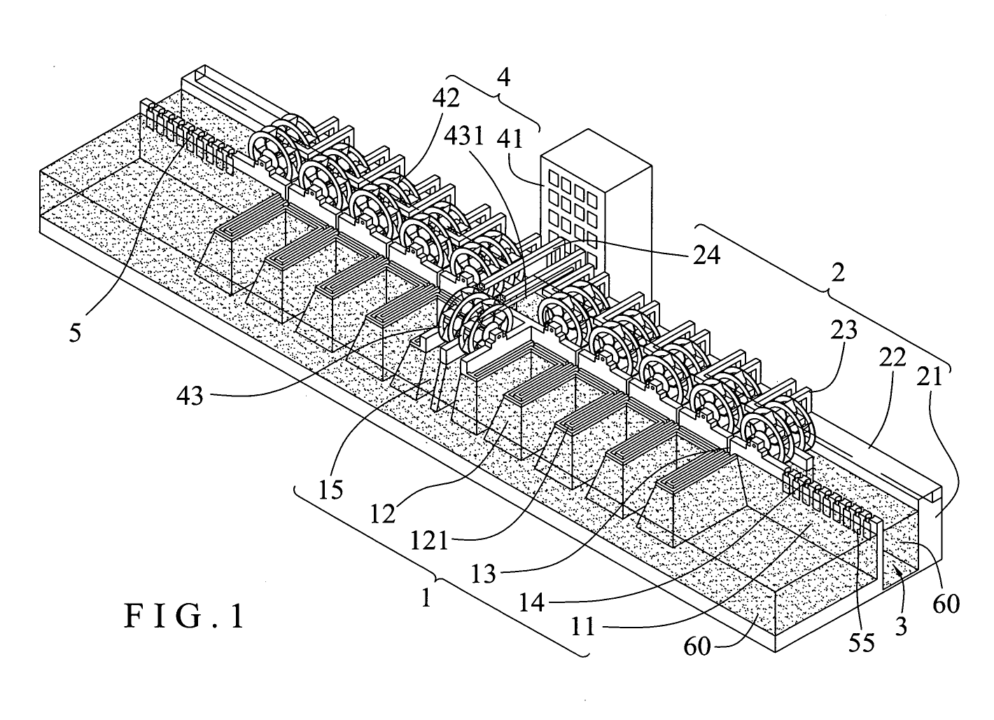

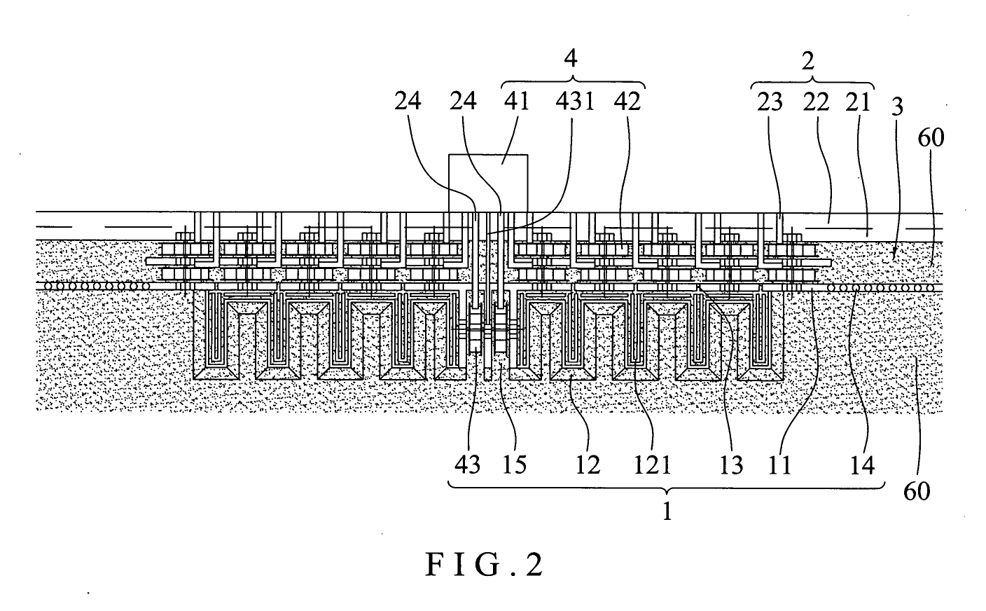

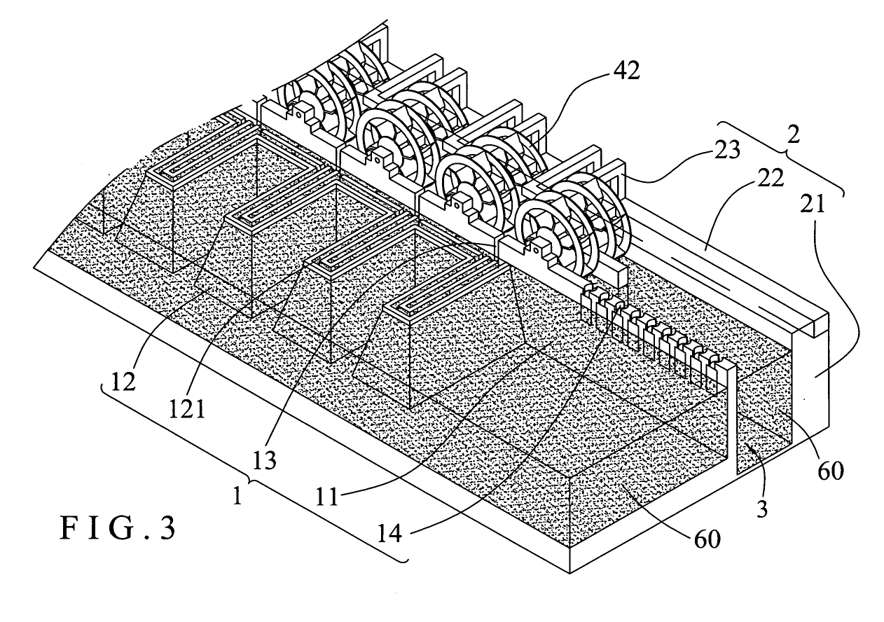

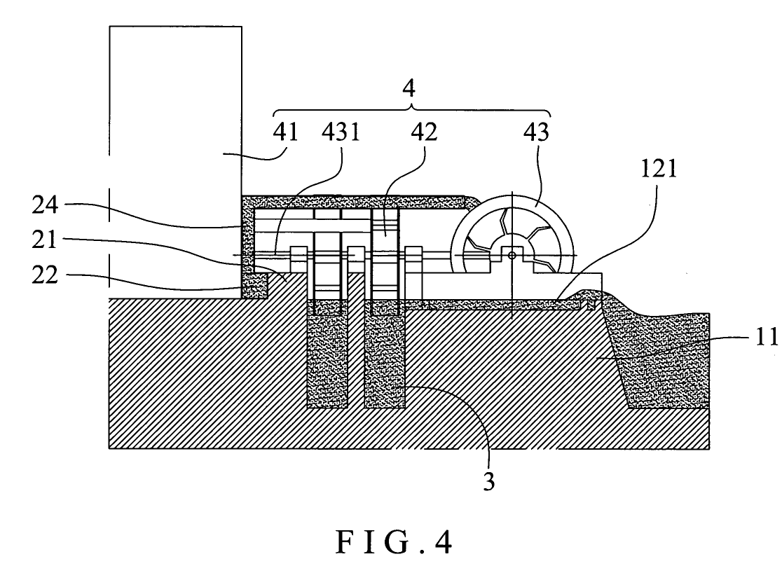

Referring to the drawings and initially to FIGS. 1-4, a generating system in accordance with the preferred embodiment of the present invention comprises an outer wall unit 1 having an outlet conduit 15, an inner wall unit 2 spaced from the outer wall unit 1, a receiving channel 3 located between the outer wall unit 1 and the inner wall unit 2 to receive salt water of the sea from the outer wall unit 1 and connected to the outlet conduit 15 of the outer wall unit 1 to deliver the salt water to the outlet conduit 15 of the outer wall unit 1, and a generating unit 4 including a plurality of generating watermills 43 located between the receiving channel 3 and the outlet conduit 15 of the outer wall unit 1 and driven by a flowing power of the salt water. Thus, the salt water flows from the receiving channel 3 to the outlet conduit 15 of the outer wall unit 1 to drive and rotate the generating watermills 43 of the generating unit 4 so as to provide a generating function.

The outer wall unit 1 includes an outer wall 11 having a first side encompassing the receiving channel 3, and a plurality of wave absorbers 12 mounted on and protruded outwardly from a second side of the outer wall 11 to reduce the impact applied by the salt water of the sea on the outer wall 11. The outer wall 11 of the outer wall unit 1 is formed with a plurality of passages 13 connected to the receiving channel 3 to introduce the salt water of the sea into the receiving channel 3. The outer wall 11 of the outer wall unit 1 has two opposite ends each formed with a plurality of mounting grooves 14 each connected to the receiving channel 3. The outlet conduit 15 of the outer wall unit 1 is formed in a middle portion of the outer wall 11 and located between the wave absorbers 12. Each of the wave absorbers 12 of the outer wall unit 1 has an inside formed with a plurality of guide ducts 121 connected to the receiving channel 3 to introduce the salt water of the sea into the receiving channel 3. The wave absorbers 12 of the outer wall unit 1 are located between the two opposite ends of the outer wall 11.

The inner wall unit 2 includes an inner wall 21 having a first side encompassing the receiving channel 3 and a second side formed with an elongated receiving chamber 22, a plurality of inlet pipes 23 each having a first end connected to the receiving chamber 22 of the inner wall 21 and a second end connected to the receiving channel 3 to introduce the salt water in the receiving channel 3 to the receiving chamber 22 of the inner wall 21, and a plurality of outlet pipes 24 each having a first end connected to the receiving chamber 22 of the inner wall 21 and a second end connected to the generating watermills 43 of the generating unit 4 and the outlet conduit 15 of the outer wall unit 1 to introduce the salt water in the receiving chamber 22 of the inner wall 21 to drive and rotate the generating watermills 43 of the generating unit 4. The inner wall 21 of the inner wall unit 2, the outer wall 11 of the outer wall unit 1 and the receiving channel 3 are combined to form a substantially U-shaped cross-sectional profile.

The generating unit 4 further includes a plurality of delivery watermills 42 each mounted in the receiving channel 3 and each connected to the second end of a respective inlet pipe 23 of the inner wall unit 2 to deliver the salt water in the receiving channel 3 through the respective inlet pipe 23 of the inner wall unit 2 to the receiving chamber 22 of the inner wall unit 2, a generating control device 41 mounted on the inner wall 21 of the inner wall unit 2, and a rotation shaft 431 connected between the generating watermills 43 and the generating control device 41 and rotatable by rotation of the generating watermills 43 to provide a generating action to the generating control device 41 which generates, control and store an electrical power. The generating watermills 43 drive a gear train (not shown) which rotates the rotation shaft 431, and the operation between the generating watermills 43, the gear train and the rotation shaft 431 is traditional and will not be further described in detail. The generating watermills 43 of the generating unit 4 are located above the outlet conduit 15 of the outer wall unit 1.

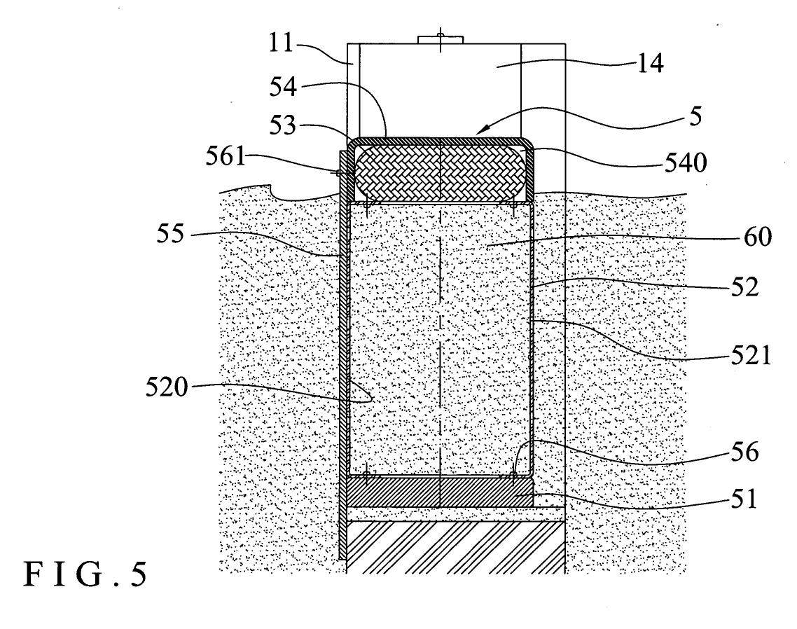

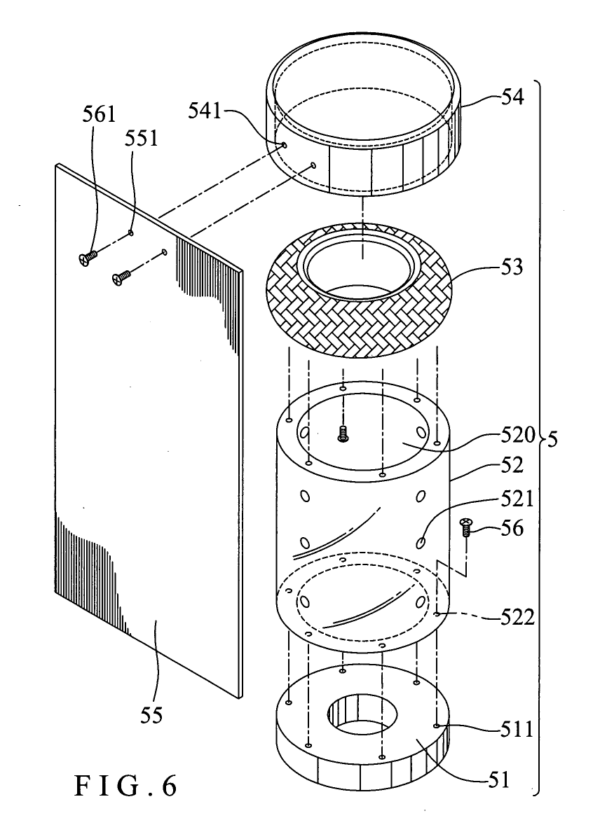

Referring to FIGS. 5 and 6 with reference to FIGS. 1-4, the generating system further comprises a plurality of floating units 5 movably mounted on the outer wall unit 1 and movable to protrude upward from the outer wall unit 1 to prevent the salt water from leaving the receiving channel 3. Each of the floating units 5 is mounted in a respective mounting groove 14 of the outer wall 11 and includes a tube 52 secured in the respective mounting groove 14 of the outer wall 11 and having a peripheral wall formed with a plurality of filling holes 521 connected to a hollow inside 520 of the tube 52 to fill the salt water of the sea into the hollow inside 520 of the tube 52, a weight 51 secured on a lower portion of the tube 52, a top cover 54 mounted on an upper portion of the tube 52 and movable in the respective mounting groove 14 of the outer wall 11, a float 53 mounted in the top cover 54 to move with the top cover 54 and rested on upper portion of the tube 52, and a catch plate 55 secured on the top cover 54 to move with the top cover 54 and protruded outwardly from a top of the outer wall 11 and a top of the receiving channel 3 to stop and prevent the salt water from leaving the receiving channel 3.

The weight 51 of each of the floating units 5 is secured on the lower portion of the tube 52 by a plurality of locking screws 56. The lower portion of the tube 52 of each of the floating units 5 has a periphery formed with a plurality of through holes 522, the weight 51 of each of the floating units 5 has a periphery formed with a plurality of screw holes 511, and each of the locking screws 56 is extended through a respective through hole 522 of the tube 52 and screwed into a respective screw hole 511 of the weight 51 to secure the weight 51 to the tube 52. The float 53 of each of the floating units 5 is made of rubber material and has an annular shape. The catch plate 55 of each of the floating units 5 is secured on the top cover 54 by a plurality of locking screws 561. The catch plate 55 of each of the floating units 5 has a periphery formed with a plurality of through holes 551, the top cover 54 of each of the floating units 5 has a periphery formed with a plurality of screw holes 541, and each of the locking screws 561 is extended through a respective through hole 551 of the catch plate 55 and screwed into a respective screw hole 541 of the top cover 54 to secure the catch plate 55 to the top cover 54. The top cover 54 of each of the floating units 5 has an inside formed with a mounting recess 540 to receive the float 53.

In operation, referring to FIGS. 1-6, the salt water of the sea is carried from the outer wall unit 1 into the receiving channel 3. At this time, partial of the salt water flowing into the receiving channel 3 is filled through the filling holes 521 into the hollow inside 520 of the tube 52 to push the float 53 and the top cover 54 upward to move the catch plate 55 upward so that the catch plate 55 is lifted to protrude outwardly from the top of the receiving channel 3 to stop and prevent the salt water from leaving the receiving channel 3. Then, the salt water directly flows from the receiving channel 3 to the outlet conduit 15 of the outer wall unit 1 to drive and rotate the generating watermills 43 of the generating unit 4 so as to provide a primary generating function. At the same time, partial of the salt water from the receiving channel 3 in turn flows through the delivery watermills 42 of the generating unit 4, the inlet pipes 23 of the inner wall unit 2, the receiving chamber 22 of the inner wall unit 2 and the outlet pipes 24 of the inner wall unit 2 and flows outwardly from the outlet pipes 24 of the inner wall unit 2 to drive and rotate the generating watermills 43 of the generating unit 4 so as to provide an auxiliary generating function.

Accordingly, the generating system is mounted on the sea coast to form an oceanic trench to collect the salt water of the sea to provide a generating function to produce an electric energy by using the natural resource to satisfy the requirements of the people and to prevent the environment from being polluted. In addition, the generating system is operated constantly by using the sea power to enhance the generating efficiency and to increase the economical profits largely. Further, the salt water directly flows from the receiving channel 3 to the outlet conduit 15 to drive and rotate the generating watermills 43 so as to provide a primary generating function, while partial of the salt water from the receiving channel 3 in turn flows through the delivery watermills 42, the inlet pipes 23, the receiving chamber 22 and the outlet pipes 24 to drive and rotate the generating watermills 43 so as to provide an auxiliary generating function, thereby greatly increasing the generating effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A generating system, comprising:
an outer wall unit having an outlet conduit;
an inner wall unit spaced from the outer wall unit;
a receiving channel located between the outer wall unit and the inner wall unit to receive salt water of the sea from the outer wall unit and connected to the outlet conduit of the outer wall unit to deliver the salt water to the outlet conduit of the outer wall unit;
a generating unit including a plurality of generating watermills located between the receiving channel and the outlet conduit of the outer wall unit and driven by a flowing power of the salt water.

2. The generating system in accordance with claim 1, wherein the outer wall unit includes an outer wall having a first side encompassing the receiving channel.

3. The generating system in accordance with claim 2, wherein the outer wall of the outer wall unit is formed with a plurality of passages connected to the receiving channel to introduce the salt water of the sea into the receiving channel.

4. The generating system in accordance with claim 2, wherein the outlet conduit of the outer wall unit is formed in a middle portion of the outer wall.

5. The generating system in accordance with claim 2, wherein the outer wall unit further includes a plurality of wave absorbers mounted on and protruded outwardly from a second side of the outer wall to reduce the impact applied by the salt water of the sea on the outer wall.

6. The generating system in accordance with claim 5, wherein the outlet conduit of the outer wall unit is located between the wave absorbers.

7. The generating system in accordance with claim 5, wherein each of the wave absorbers of the outer wall unit has an inside formed with a plurality of guide ducts connected to the receiving channel to introduce the salt water of the sea into the receiving channel.

8. The generating system in accordance with claim 5, wherein the wave absorbers of the outer wall unit are located between two opposite ends of the outer wall.

9. The generating system in accordance with claim 2, wherein the inner wall unit includes:
an inner wall having a first side encompassing the receiving channel and a second side formed with an elongated receiving chamber;
a plurality of inlet pipes each having a first end connected to the receiving chamber of the inner wall and a second end connected to the receiving channel to introduce the salt water in the receiving channel to the receiving chamber of the inner wall;
a plurality of outlet pipes each having a first end connected to the receiving chamber of the inner wall and a second end connected to the generating watermills of the generating unit and the outlet conduit of the outer wall unit to introduce the salt water in the receiving chamber of the inner wall to drive and rotate the generating watermills of the generating unit.

10. The generating system in accordance with claim 9, wherein the inner wall of the inner wall unit, the outer wall of the outer wall unit and the receiving channel are combined to form a U-shaped cross-sectional profile.

11. The generating system in accordance with claim 9, wherein the generating unit further includes a plurality of delivery watermills each mounted in the receiving channel and each connected to the second end of a respective inlet pipe of the inner wall unit to deliver the salt water in the receiving channel through the respective inlet pipe of the inner wall unit to the receiving chamber of the inner wall unit.

12. The generating system in accordance with claim 11, wherein the generating watermills of the generating unit are located above the outlet conduit of the outer wall unit.

13. The generating system in accordance with claim 2, wherein the generating system further comprises a plurality of floating units movably mounted on the outer wall unit and movable to protrude upward from the outer wall unit to prevent the salt water from leaving the receiving channel.

14. The generating system in accordance with claim 13, wherein:
the outer wall of the outer wall unit has two opposite ends each formed with a plurality of mounting grooves each connected to the receiving channel;
each of the floating units is mounted in a respective mounting groove of the outer wall and includes:
a tube secured in the respective mounting groove of the outer wall and having a peripheral wall formed with a plurality of filling holes connected to a hollow inside of the tube to fill the salt water into the hollow inside of the tube;
a weight secured on a lower portion of the tube;
a top cover mounted on an upper portion of the tube and movable in the respective mounting groove of the outer wall;
a float mounted in the top cover to move with the top cover and rested on upper portion of the tube;
a catch plate secured on the top cover to move with the top cover and protruded outwardly from a top of the outer wall and a top of the receiving channel to stop and prevent the salt water from leaving the receiving channel.

15. The generating system in accordance with claim 14, wherein:
the weight of each of the floating units is secured on the lower portion of the tube by a plurality of locking screws;
the lower portion of the tube of each of the floating units has a periphery formed with a plurality of through holes;
the weight of each of the floating units has a periphery formed with a plurality of screw holes;
each of the locking screws is extended through a respective through hole of the tube and screwed into a respective screw hole of the weight to secure the weight to the tube.

16. The generating system in accordance with claim 14, wherein:
the float of each of the floating units is made of rubber material and has an annular shape;
the top cover of each of the floating units has an inside formed with a mounting recess to receive the float.

17. The generating system in accordance with claim 14, wherein the
the catch plate of each of the floating units is secured on the top cover by a plurality of locking screws;
the catch plate of each of the floating units has a periphery formed with a plurality of through holes;
the top cover of each of the floating units has a periphery formed with a plurality of screw holes;
each of the locking screws is extended through a respective through hole of the catch plate and screwed into a respective screw hole of the top cover to secure the catch plate to the top cover.

18. The generating system in accordance with claim 14, wherein the salt water in the receiving channel is filled through the filling holes into the hollow inside of the tube to push the float and the top cover upward to move the catch plate upward so that the catch plate is lifted to protrude outwardly from the top of the receiving channel to stop and prevent the salt water from leaving the receiving channel.

19. The generating system in accordance with claim 1, wherein the salt water flows from the receiving channel to the outlet conduit of the outer wall unit to drive and rotate the generating watermills of the generating unit.

20. The generating system in accordance with claim 1, wherein the salt water from the receiving channel in turn flows through the delivery watermills of the generating unit, the inlet pipes of the inner wall unit, the receiving chamber of the inner wall unit and the outlet pipes of the inner wall unit and flows outwardly from the outlet pipes of the inner wall unit to drive and rotate the generating watermills of the generating unit.
